(19) United States
(12) Patent Application Publication
(10) Pub. No.: US 2009/0056638 A1
(43) Pub. Date: Mar. 5, 2009

(54) Aquarium Apparatus

(76) Inventor: Shao-Chieh TING, Banciao City (TW)

Correspondence Address: TROXELL LAW OFFICE PLLC, SUITE 1404, 5205 LEESBURG PIKE, FALLS CHURCH, VA, 22041, US

(21) Appl. No.: 12/126,536

(22) Filed: May 23, 2008

(30) Foreign Application Priority Data
Aug. 31, 2007 (TW) 096214567

(51) Int. Cl. A01K 63/04; A01K 63/00

(52) U.S. Cl. 119/248; 119/263

(57) ABSTRACT

An “aquarium apparatus” comprises an aquarium and a hood, wherein, a partition panel and an porous filter substrate separate the internal cavity of the aquarium into three partitions, namely first foreground compartment for aqua-cultivating zone, second background compartment for accommodating heating rod, filter device, biochemical ball, adjustment of the water quality and enhanced filtration vat as well as underwater aerating pump; third partition is formed beneath the porous filter substrate to include a water regulator, a filtering grille tray with plural ceramics rings and a set of IR LEDs.

### TECHNICAL FIELD

The present invention relates to an “aquarium apparatus”, particularly for one that the water in the aquarium can be constantly purified with sufficient oxygen content without necessity of changing water and the growth and breed of the aquatic life can be enhanced therein.

### PRIOR ARTS

For many people in the society nowadays, the primary purpose of cultivating the aquatic creatures and plants in the room or office occasionally is to relax the working pressures born accordingly. However, the most common way of such aquatic cultivating method in the room or office is to use a glass fish tank with air conditioner in construction so as to keep the necessary oxygen content therein. For choosy hobbyist, he may install an illuminating device above the glass tank to maintain the appropriate illumination. Thus, the aquatic life cultivating effect can be achieved by such simple fish tank device.

However, a lot of issues emerge with such aquatic life cultivating method aforesaid. The critical one is that the aquatic creatures therein die of insufficient oxygen content or exceeding ammonia concentration in water. Besides, fish tank must be washed frequently and the water therein should be changed often that becomes a bothering issue. Realizing and addressing the drawbacks mentioned above as well as basing on the keeping improvement spirit, the applicant of the present invention is eager to research and develop to find a solving approach for a long time. Eventually, the “aquarium apparatus” of the present invention is contrived to offer an optimal aquatic life cultivating ecological environment and reduce the miscellaneous and tedious work burden incurred to the breeders accordingly.

### SUMMARY OF THE INVENTION

The primary object of the present invention is to provide a special design of an “aquarium apparatus”, which comprises an aquarium and a hood, wherein, a partition panel and an aerating porous filter substrate separate the internal cavity of the aquarium into three partitions, namely, first foreground compartment for aqua-cultivating zone, second background compartment for accommodating various adjusting and filtering devices such as heating rod, filter device, biochemical ball, adjustment of the water quality and enhanced filtration vat as well as immersible underwater aerating pump; third partition is formed beneath the porous filter substrate to include a water regulator, a grille tray, plural ceramics rings and a set of IR LEDs as an “aquarium apparatus” with better aquatic life cultivating environment.

Another object of the present invention is to provide a special design of an “aquarium apparatus”, which comprises an aquarium and a hood, wherein, a the internal bottom of said aquarium descends downwards into obtuse conic shape having a water regulator with plural ceramics rings dispersed around to let bacteria of anaerobic de-nitrification attach and grow thereon such that the quantity of the ceramics rings being arbitrary in accordance with the quantity of the aquatic life therein; By means of the water regulator and the descending obtuse conic shape in the internal bottom of the aquarium, the water filled therein is forced to flow freely instead of relying on the motor in manner of the slower the water is, the less the oxygen content is so that the bacteria of anaerobic de-nitrification will breakdown unwanted nitrate (MNO₃) and nitrite (MNO₂) compounds into nitrogen for evaporating into air; Thereby, the water in the aquarium can be constantly purified without necessity of changing water as the growth of the algae and fungi is precluded therein.

The other object of the present invention is to provide a special design of an “aquarium apparatus”, which comprises an aquarium and a hood, wherein, plural water intake areas each with plural water inlet bores in extending upwards manner are disposed at the backside of a partition panel so that the water in the aquarium can flow into each backside water intake area of the partition panel with cascaded flowing upwards manner and let all the fish excrements precipitated in the bottom of the aquarium are carried up along the water flow into the backside space of the partition panel for being collected to achieve the effects in getting rid of fish excrements and water filtration; Meanwhile, plural racking pins corresponding to each water intake area surrounding are disposed at the front side of the partition panel, namely aquatic life cultivating zone, to hold a biochemical cotton pad respectively thereon; By properly selecting biochemical cotton pad of suitable density, the water in the aquarium can flow into each backside water intake area of the partition panel via each biochemical cotton pad for achieving the free running and filtering effects of the water while the shrimp roes of flea-shape and fish fry or young shrimps are prevented from sucking and passing into the filtering trough therein. Therefore, the spawns of young shrimps or shrimp roes of flea-shape as well as coral and sea anemone, which can serve as biological bait, can be suitably aquatically cultivated therein.

### BRIEF DESCRIPTION OF THE DRAWINGS

FIG. 1 is the perspective view showing the integral assembly for the present invention.

FIG. 2 is the perspective view showing the exploded aquarium for the present invention.

FIG. 2A is the overlook view showing the base of the aquarium for the present invention.

FIG. 3 is the perspective view showing the exploded hood for the present invention.

FIG. 4 is the overlook view showing the assembly of the aquarium for the present invention.

FIG. 4A is the perspective view showing the grille box of the ceramics rings in the base of the aquarium for the present invention.

FIG. 5 is the perspective rearview showing the partition panel with associated components for the present invention.

FIG. 6 is the partial enlarged view showing the portion taken from the circled corner of the FIG. 5.

FIG. 7 is the perspective front view showing the partition panel with associated components for the present invention.

FIG. 8 is the partial enlarged view showing the portion taken from the circled corner of the FIG. 7.

FIG. 9 is the perspective view showing the exploded immersible underwater aerating pump for the present invention.

FIG. 10 is the lateral partial section view showing the background compartment from the side of heating rod for the present invention.

FIG. 11 is the perspective view showing the exploded internal structure for another embodiment of the present invention.

### DETAILED DESCRIPTION OF THE PREFERRED EMBODIMENTS

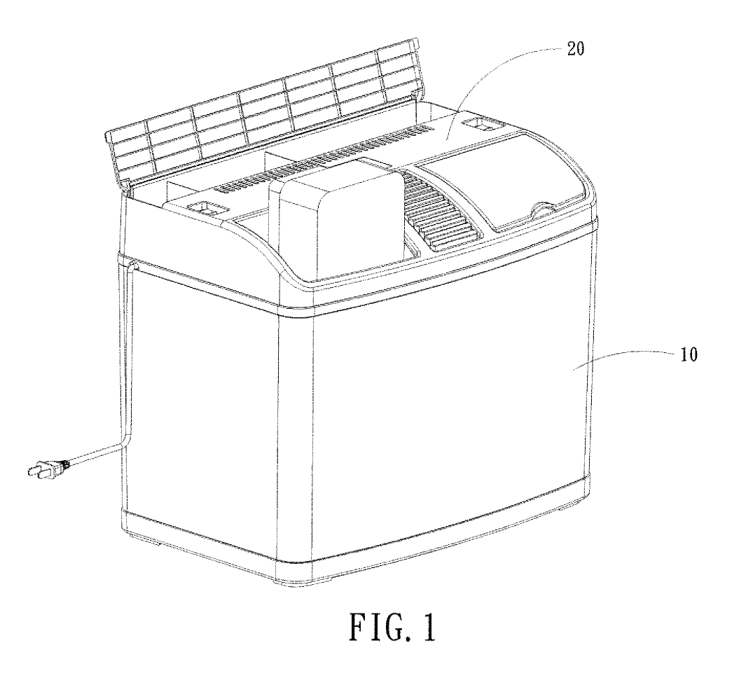

The structural feature and other functions as well as objects of the present invention are detailed described as below in accompany with the associated drawings. As shown in the FIG. 1, the design of the “aquarium apparatus” for the present invention mainly comprises an aquarium 10 and a hood 20, wherein,

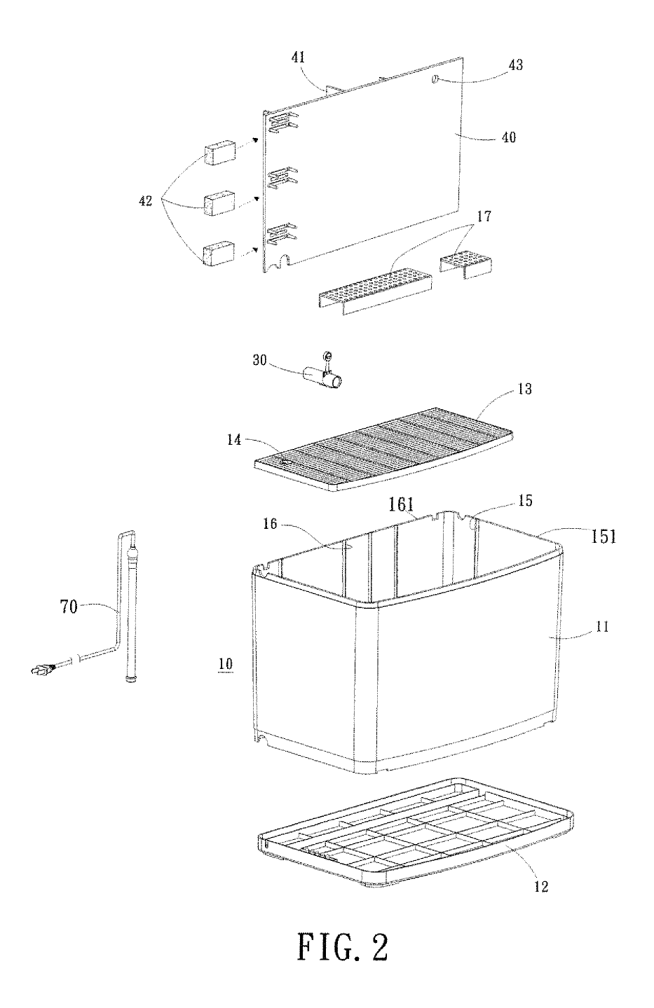

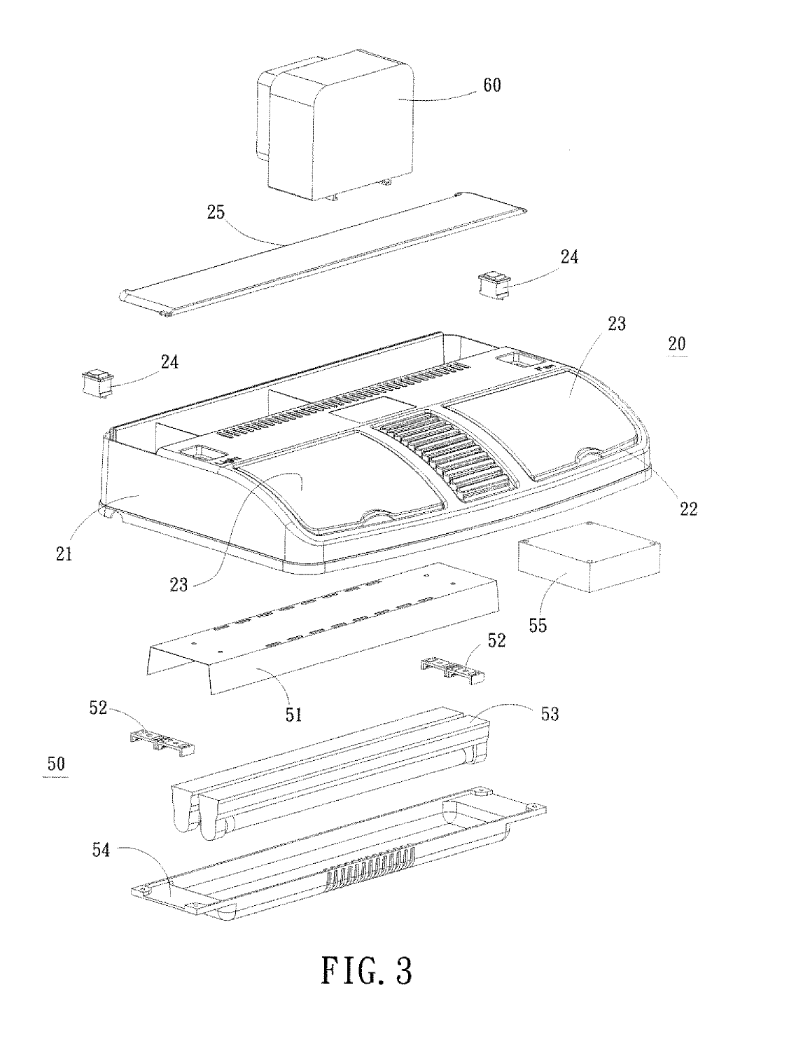

Said aquarium 10, shown as in the FIG. 2 (please also refer to FIG. 4), comprises a tank assembly 11, a bottom base 12 and a lower section aerating porous filter substrate 13 with a corner through hole 14 to be fitted with a water regulator 30;

A partition panel 40, which is disposed in said tank assembly 11 to separate the internal cavity thereof into foreground compartment A and background compartment B such that its backside having plural dividing slats 41 its front side having plural biochemical cotton pads 42, has a fixing hole 43 for inserting elbow manifold 93 therein perforated at the upper corner thereof;

A pair of parallel symmetrical guiding rails 15 are juxtaposed inside of the opposed sidewalls 151 of said tank assembly 11 for taking two corresponding sides of the partition panel 40 to slide therein up to the final proper position firmly in said tank assembly 11 thereof;

Multiple gripping guiding grooves 16 are parallel configured on the backside rear panel 161, which is adjacent to said pair of sidewalls 151, for being inset therein by the plural dividing slats 41 on the backside of said partition panel 40 so that multiple divisions are formed in the background compartment B (as shown in the FIGS. 2, 2A and 4);

Other than the aqua-cultivating foreground compartment A, the multiple divisions, which are separated by the plural dividing slats 41 with inversed U-shaped rests 17 in the background compartment B, are served to locations for accommodating of heating rod 70, filter device 80, biochemical ball (not shown in the figures), adjustment of the water quality and enhanced filtration vat as well as the immersible underwater aerating pump 90 respectively;

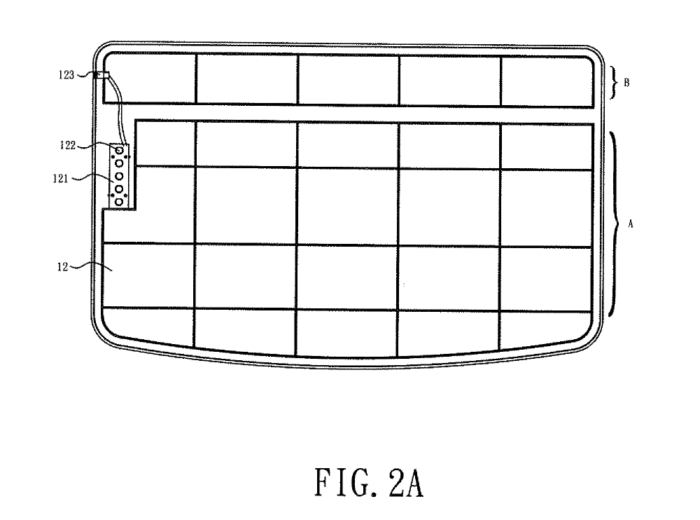

Said hood 20, which is set over the aquarium 10 as shown in the FIG. 3, mainly comprises a hood assembly 21 and an illuminating fixture 50, wherein, plural observing windows 22 with each pivotal hinged cover 23 are disposed on said hood assembly 21, a left observing window 22 with left hinged cover 23 and a right observing window 22 with right hinged cover 23 are disposed on the front lower side thereof in this exemplary embodiment;

A pivotal movable lid 25, which is disposed at the rear section of said hood assembly 21, can be turned up by virtue of the engagement of the two pivot axles thereof with the corresponding mated pivot sinuses on the hood assembly 21 for easily accessing to the filtrating cotton mass 81, biochemical cotton mass 82 and heating rod 70 in the background compartment B to do maintenance replacement or adjustment;

Said illuminating fixture 50, which is configured in the bottom section of said hood assembly 21, comprises a reflector 51, two lamp tube brackets 52, two illuminating lamps 53, a lampshade 54 and a heat dissipating blower 55.

In this exemplary embodiment, an additional automatic feeder 60 can be further disposed on anyone observing window 22 of the hood assembly 21 in displacement of corresponding removed pivotal hinged cover 23 for expediting the installation of the automatic feeder 60.

In this exemplary embodiment, the automatic feeder 60 is disposed on the left observing window 22 in displacement of left removed pivotal hinged cover 23; Meanwhile, two switches 24 are provided with the hood assembly 21 for turning off and on of the illuminating fixture 50 and heat dissipating blower 55 respectively.

Please further refer to the FIG. 4, the internal cavity of said tank assembly 11 is separated into foreground compartment A and background compartment B by the partition panel 40; besides, the internal space of said background compartment B is further divided into multiple divisions by the plural dividing slats 41 on the backside of said partition panel 40 with inversed U-shaped rest 17 for accommodating heating rod 70, filter device 80, biochemical ball not shown in the figures, adjustment of the water quality and enhanced filtration vat as well as the immersible underwater aerating pump 90 respectively;

In this exemplary embodiment, the internal space of said background compartment B is further divided into five divisions by four dividing slats 41 on the backside of said partition panel 40 with inversed U-shaped rest 17 for accommodating of heating rod 70, filter device 80, biochemical ball, adjustment of the water quality and enhanced filtration vat as well as the immersible underwater aerating pump 90 respectively;

Moreover, an aerating porous filter substrate 13 with a corner through hole 14 to be fitted with a water regulator 30 is disposed in the lower section of said tank assembly 11 to configure third compartment;

The internal bottom of said tank assembly 11 descends towards the corner through hole 14 with obtuse conic shape so that the water filled in the foreground compartment A of the tank assembly 11 is forced to flow through the water regulator 30 by the location difference of the static water pressure for supplying the contained oxygen needed in the aqua-cultivation by the regulation of the water flow instead of relying on the motor.

Please furthermore refer to the FIGS. 4 and 4A, beneath said porous filter substrate 13, a black filterable grille tray 19 is fixed on the internal bottom of the tank assembly 11 by setting pegs 191 thereon, wherein the grille tray 19, plural of ceramics rings 18 are dispersed to let bacteria of anaerobic de-nitrification attach and grow thereon;

Besides, because the internal bottom of said tank assembly 11 descends towards the corner through hole 14 with obtuse conic shape with location difference of the static water pressure, the water therein is forced to flow through the ceramics rings 18, where the bacteria of anaerobic de-nitrification will breakdown unwanted nitrate (MNO₃) and nitrite (MNO₂) compounds into nitrogen for evaporating into air; Thereby, the water in the aquarium 10 can be constantly purified without necessity of changing water as the growth of the algae and fungi is precluded therein.

Please furthermore refer to the FIGS. 2 and 2A, beneath said aerating porous filter substrate 13, a PCB 121 with a set of IR LEDs 122 and a switch 123 are provided to create healthy ecological environment for cultivating Rhodospira bacteria of very high nutrient value so that the growth and breed of the aquatic life in the aquarium can be expedited.

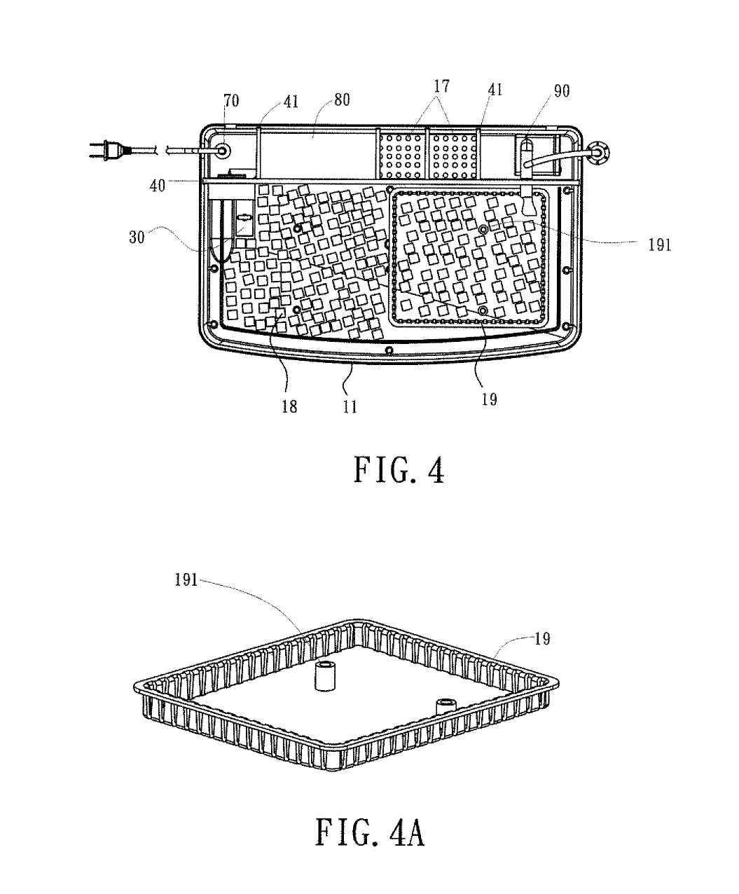

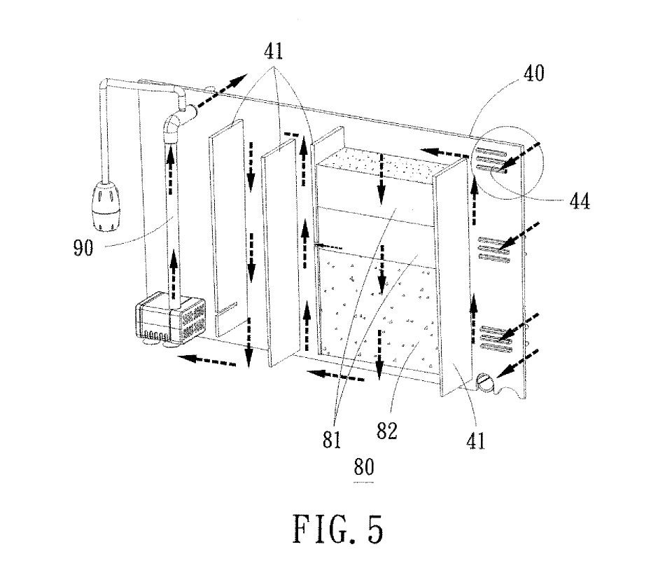

Please furthermore refer to the FIGS. 5 and 6, which are the perspective rearview showing the partition panel 40 with associated components and water flow directions for the present invention and the partial enlarged view showing the portion taken from the circled corner indicated, where the heating rod 70, filter device 80, biochemical ball, adjustment of the water quality and enhanced filtration vat as well as the immersible underwater aerating pump 90 are accommodated respectively;

For respective position of each component at the backside of the partition panel 40, the heating rod 70 is set at the rightmost and the immersible underwater aerating pump 90 is set at the leftmost as well as the filter device 80 is set adjacent to the heating rod 70 with each dividing slat 41 is provided in between neighboring components to separate each other; wherein, said filter device 80, which includes a filtrating cotton mass 81 and a biochemical cotton mass 82, serves to filter the impurities in the water.

Said water regulator 30, which is disposed at lower corner of the partition panel 40 with whose one end passing through the corner through hole 14 on the porous filter substrate 13 for projecting over the topside thereof as shown in the FIG. 2, can adjust the flux of the water flow rate in accordance with the quantity of the aquatic life so that the bacteria of anaerobic de-nitrification (such as Rhodospira bacteria) cultivated in said aerating porous filter substrate 13 adequately achieve the effect of biochemical filtration.

Corresponding to each biochemical cotton pad 42, disposed at the backside of the partition panel 40 is a water intake area 44, which is made of plural water inlet bores in extending upwards manner so that the water in the aquarium 10 can flow into each backside water intake area 44 of the partition panel 40 via each biochemical cotton pad 42 with cascaded flowing upwards manner due to extending upwards design of all water inlet bores; Thereby, all the fish excrements precipitated in the bottom of the aquarium 10 are carried up along the water flow (shown as the direction of the arrowhead) into the backside space of the partition panel 40, namely background compartment B, and are collected on the troughs forming on the filtrating cotton mass 81 and biochemical cotton mass 82 respectively of the filter device 80; Thus, the effects in collecting fish excrements and filtering residues can be enhanced. Meanwhile, by means of the biochemical cotton pad 42, the shrimp roes of flea-shape and fish fry or young shrimps are prevented from sucking and passing into the filtering trough in the backside background compartment B of the partition panel 40.

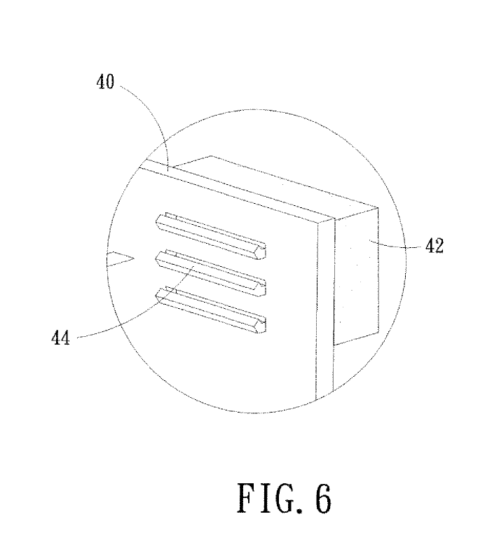

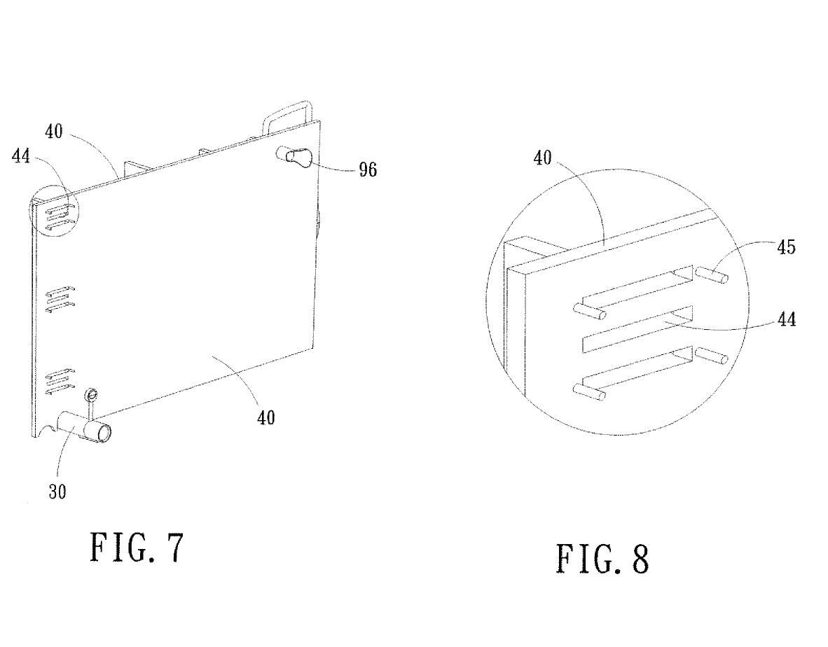

Please simultaneously refer to the FIGS. 7 and 8 which are the perspective front view showing the partition panel with associated components and the partial enlarged view showing the portion taken from the circled corner indicated.

Corresponding to each water intake area 44 surrounding, disposed at the front side of the partition panel 40 are plural racking pins 45, which are used to hold the biochemical cotton pads 42 thereon (not shown in the figures);

By properly selecting biochemical cotton pad 42 of suitable density, the water in the aquarium 10 can flow into each backside water intake area 44 of the partition panel 40 via each biochemical cotton pad 42 for achieving the free running and filtering effects of the water while the shrimp roes of flea-shape and fish fry or young shrimps are prevented from sucking and passing into the filtering trough therein.

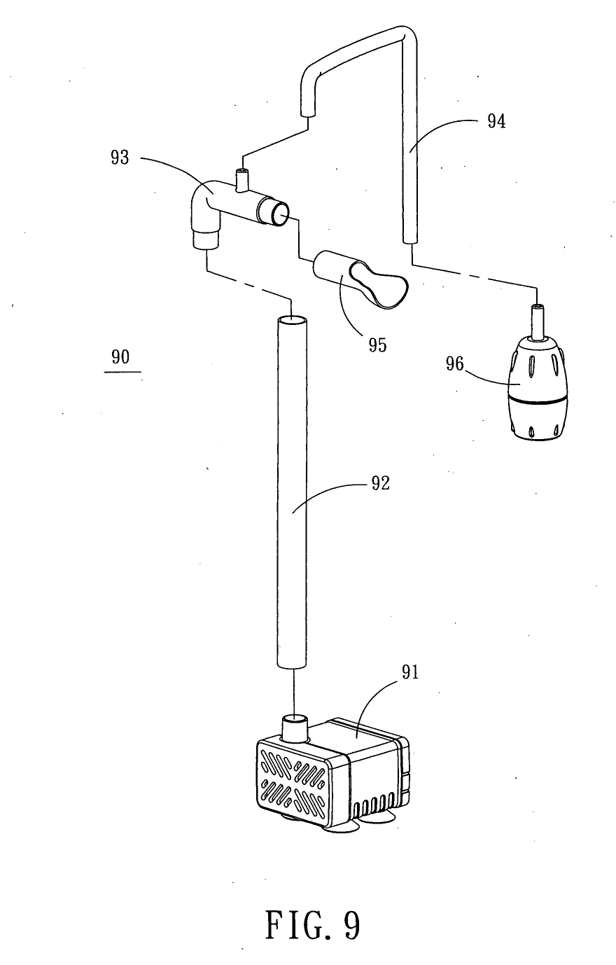

Please also simultaneously refer to the FIGS. 7 and 9, which are the perspective front views showing the partition panel with associated components and the exploded immersible underwater aerating pump 90 for the present invention.

Said immersible underwater aerating pump 90 comprises a submersible submerged watertight motor 91, a linear plastic tube 92, a 3-way elbow manifold 93, a flexible tube 94, a lingulate tube 95 and an aerating air throttle 96, wherein,

Said submerged watertight motor 91, which is disposed in the aquarium 10, has upper fitting connects to one end of the linear plastic tube 92 such that the other end of the linear plastic tube 92 connects to the lower end of the 3-way elbow manifold 93, whose other two ends connect to one end of the flexible tube 94 and to one end of the lingulate tube 95 respectively;

The other end of the lingulate tube 95 protrudes into the cultivating area of the tank assembly 11, namely foreground compartment A, while the other end of the flexible tube 94 connects to the aerating air throttle 96, which is set outside of the aquarium 10;

Thus, by means of the immersible underwater aerating pump 90, the oxygen content in the water is increased to sufficiently supply the adequate oxygen to the aquatic life in the aquarium for life subsistence.

By the facility of heating rod 70, filter device 80, biochemical ball, adjustment of the water quality and enhanced filtration vat as well as the immersible underwater aerating pump 90 and the illuminating fixture 50, an “aquarium apparatus” with features of capabilities in adjusting water temperature, increasing oxygen content in the water, filtering the impurities in the water and giving proper illumination timely is provided so that an optimal ecological aqua-cultivating environment for best suitable to the aquatic life is created for undertaking the breeding of the aquatic creatures and plants

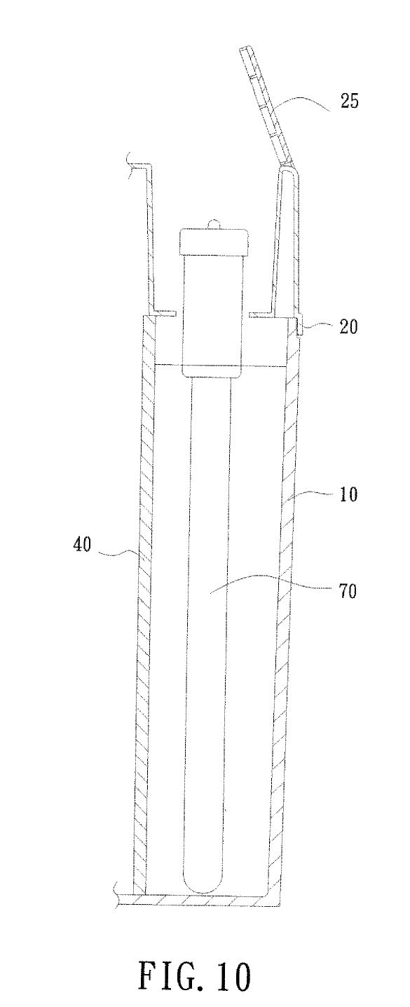

Please further refer to the FIG. 10, which is the lateral partial section view showing the background compartment from the side of heating rod 70 for the present invention. Please also refer to other figures, especially the FIGS. 2 and 4, the “aquarium apparatus” of the present invention with the hood 20 setting over the aquarium 10, wherein, the partition panel 40 separates the internal cavity of the aquarium 10 into foreground compartment A for aqua-cultivating zone and background compartment B for accommodating various adjusting and filtering devices; Said background compartment B is further divided into multiple divisions by the plural dividing slats 41 on the partition panel 40 and let one of the multiple divisions is assigned as heating division for accommodating the heating rod 70 so as to achieve the suitably adjustment and control of the water temperature.

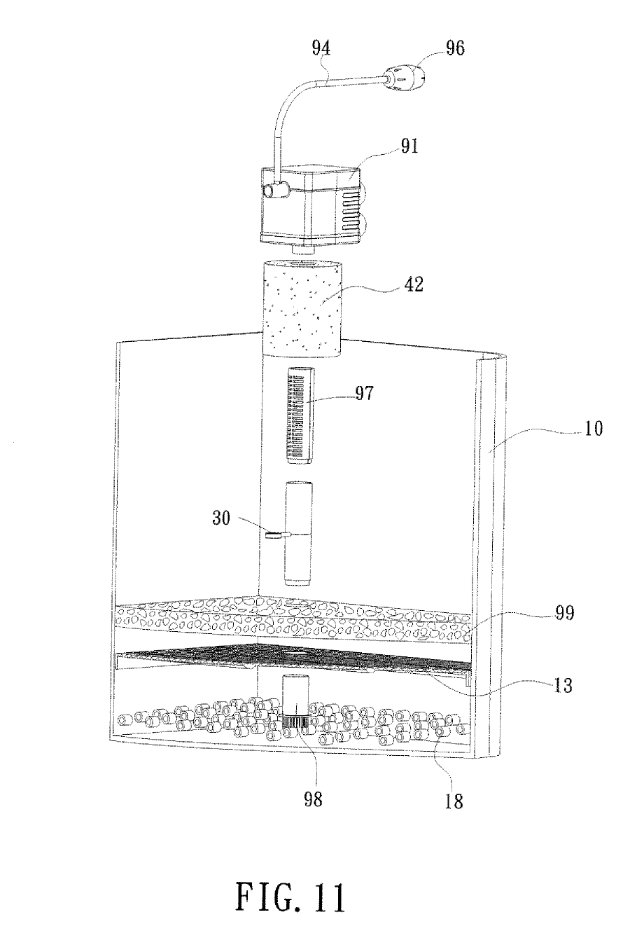

FIG. 11 is the perspective view showing the exploded internal structure for another embodiment of the present invention with flat internal bottom instead of descending internal bottom of the aquarium 10. With such flat internal bottom of the aquarium 10, starting from the bottom upwards, a ceramics ring 18 layer, an aerating porous filter substrate 13 layer and a gravel 99 layer are stacked orderly; Similarly, starting from the bottom upwards, a lower duct 98, a water regulator 30, an upper duct 97 with a biochemical cotton pad 42 and a submersible submerged watertight motor 91 with a flexible tube 94 connecting to an aerating air throttle 96 are consecutively jointed to construct a submersible biochemical filter for adequately achieving the biochemical filtering effect.

Besides, in this exemplary embodiment an additional automatic feeder 60 can be further disposed on the hood 20 for automatically supplying necessary food to the aquatic life so that the automatic feeding operation by the breeder can be helpfully improved.

In conclusion all the disclosure heretofore, the design of the “aquarium apparatus” for the present invention has features in novelty of innovative improvement in technological means and beyond the obviousness of the prior arts as well as practical industrial application and usage, which meets the essential criterion of the patentability. Accordingly, the patent application is submitted for your perusal and examination with hope of granting a patent, which is highly appreciated by us.

What is claimed is:

1. An “aquarium apparatus” comprises an aquarium, a water regulator, an aerating porous filter substrate, a group of ceramics rings, a set of IR LEDs, a partition panel, a hood and a class of dividing slats, wherein,
said aquarium, whose internal bottom is in descending obtuse conic shape, has plural ceramics rings dispersed thereon;
said water regulator, which is disposed beneath the porous filter substrate with one end projecting over the topside thereof, serves to adjust the flux of the water flow rate so that the slower the water flow is, the less the oxygen content is;
said porous filter substrate, which is disposed over the ceramics rings, has gravels spread thereon;
said ceramics rings, which are dispersed in the internal bottom of the aquarium, creates an oxygen-less ecological environment to let bacteria of anaerobic de-nitrification attach and grow thereon so as to breakdown unwanted nitrate (MNO₃) and nitrite (MNO₂) compounds into nitrogen for evaporating into air so that the water in the aquarium can be constantly purified without necessity of changing water as the growth of the algae and fungi is precluded therein;
said IR LEDs, which are disposed beneath said aerating porous filter substrate, creates an luminous oxygen-less ecological environment in association with said ceramics rings for cultivating Rhodospira bacteria so that the growth and breed of the aquatic life in the aquarium can be expedited;
said partition panel, which is inserted in the aquarium, separates the internal cavity of the aquarium into foreground compartment for aqua-cultivating zone and background compartment for accommodating various adjusting and filtering devices;
said hood, which is set over the aquarium, at least comprises an illuminating fixture and plural observing windows as well as an additional automatic feeder if desired; and
said dividing slats, which are disposed on the backside of said partition panel, separates the background compartment into multiple divisions for accommodating heating rod, filter device, biochemical ball, adjustment of the water quality and enhanced filtration vat as well as the immersible underwater aerating pump respectively,

2. The “aquarium apparatus” as recited in claim 1, wherein, plural water intake areas each with plural water inlet bores in extending upwards manner are disposed at the backside of the partition panel, and plural racking pins corresponding to each water intake area surrounding are disposed at the front side of the partition panel to hold a biochemical cotton pad respectively thereon so that the water in the aquarium can flow into each backside water intake area of the partition panel via each biochemical cotton pad with cascaded flowing upwards manner and let all the fish excrements precipitated in the bottom of the aquarium are carried up along the water flow into the backside space of the partition panel for being collected.

3. The “aquarium apparatus” as recited in claim 1, wherein, said filter device has features for achieving the free running and filtering effects of the water while the shrimp roes of flea-shape and fish fry or young shrimps are prevented from sucking and passing into the filtering trough therein.

4. An “aquarium apparatus” comprises an aquarium, an aerating porous filter substrate, a group of ceramics rings and a biochemical filter, wherein,
said aquarium, whose internal bottom is in flat shape, has plural ceramics rings dispersed thereon;
said porous filter substrate, which is disposed over the ceramics rings, has gravels spread thereon;
said ceramics rings are dispersed in the internal bottom of the aquarium; and
said biochemical filter comprises an aerating air throttle, a submersible submerged watertight motor with a flexible tube, an upper duct with a biochemical cotton pad, a water regulator and a lower duct.
